(19) United States
(12) Patent Application Publication
(10) Pub. No.: US 2004/0094728 A1
(43) Pub. Date: May 20, 2004

(54) Device for sintering, removing material and/or labeling by means of electromagnetically bundled radiation and method for operating the device

(76) Inventors: Frank Herzog, Lichtenfels (DE); Kerstin Herzog, Lichtenfels (DE)

Correspondence Address: MERCHANT & GOULD PC, P.O. BOX 2903, MINNEAPOLIS, MN, 55402-0903, US

(21) Appl. No.: 10/415,195

(22) PCT Filed: Oct. 30, 2001
(86) PCT No.: PCT/DE01/04063

(30) Foreign Application Priority Data
Oct. 30, 2000 (DE) 100 53 742.1

(51) Int. Cl. G01V 8/00; G01N 21/86

(52) U.S. Cl. 250/559.06; 250/559.22

(57) ABSTRACT

The invention relates to a device for sintering, removing material and/or labeling by means of electromagnetically bundled radiation, especially a laser sintering machine and/or a laser surface-processing machine. The device comprises a construction space (3) which is accommodated in a machine housing (2) and in which the following are provided: a scanner (4), into which the beam (5) of a sintering laser (6) is coupled; a vertically displaceable workpiece platform (7); and a material supply device comprising a coater for supplying sintering material in powder, paste or liquid form to the process area above the workpiece platform, from a supply container. Said scanner (4) is arranged on a scanner support (8) which can be displaced by a motor over the workpiece platform (7) in the manner of a cross-slide. Driving motor elements of the scanner support (8) are connected to a control computer (9) of the device (1) and are controlled by the same during the construction process in order to move the scanner (4) over the workpiece platform (7).

The invention relates to a device for sintering, removing material and/or labeling by means of electromagnetically bundled radiation, especially a laser sintering machine and/or a laser-surface processing machine suitable for carrying out stereolithographic construction processes. A laser sintering machine known from DE 198 46 478 displays a machine housing in which a construction space is accommodated. In the upper region of the construction space is situated a scanner, into which the beam of a sintering laser is transmitted. Arranged under the scanner is a vertically-movable workpiece platform, in the region of which is provided a material supply device comprising a coater that serves to feed sintering material in powder, paste, or liquid form from a supply container into the process area above the workpiece platform.

By means of the scanner, the focus of the laser beam is guided over the sintering-material layer located on the workpiece platform such that the sintering material is heated, melted down, and thereby solidified.

The known laser sintering machine is disadvantageous in that, using this machine, large-volume components can be produced only with difficulty. That is to say, if through the known scanning arrangement the laser beam is guided to edge regions lying relatively far apart, changes of the focus inevitably result and thus of the incident energy density, so that a sufficient homogeneity and stability of the sintered material in the edge region of relatively large work pieces is no longer ensured. Moreover, relatively large beam deviations in the edge region of stereolithographically produced workpieces lead to imprecisions. Accordingly, due to the obliquely-incident laser beam, problems also arise in labeling and removing material from the edge regions.

The invention is based on the task of further developing a device for sintering, removing material and/or labeling by means of electromagnetically bundled radiation with the further features of the preamble of claim 1 in such a way that, using the device, relatively large-volume components of high precision can be produced, ablated and/or labeled. This task is accomplished through the characterizing features of claim 1, and advantageous further developments result from the dependent claims 2-12. It is a further task of the invention to specify a method of operating a device having the features of claim 1, which method produces, ablates and/or labels large-volume, high-precision, and stable work pieces. This task is likewise accomplished through the method claims 13ff.

Considered the core of the invention is the fact that, in contrast to the known prior art, the scanner is not fixedly mounted in the upper region of the construction space, but rather is attached to a scanner support that can be moved over the workpiece platform in the manner of a cross slide, the motor drive elements of the scanner support being connected to a control computer and being controlled by the latter during the construction process for the movement of the scanner over the workpiece platform. It is thus possible to move the scanner to an essentially central position over the construction zone about to be exposed and to guide the laser beam from this central position onto the construction layer by means of the scanner mirror with only small angular deviations from the vertical. Through these measures, changes in focus are largely avoided and the construction quality is thereby improved. In addition, it is possible to divide the construction layer into zones that can be addressed by the scanner support. Inside the zones, the layer is essentially scanned by the laser beam focus through the steering of the scanner.

In addition, it can be advantageous to arrange the scanner support over the workpiece platform in a vertically displaceable manner. This results in additional variation possibilities with respect to the energy density acting upon the construction layer. In particular, the possibility arises of retouching already-completed side regions superficially in the sense of a fine processing, e.g. to ablate imperfections, to densify surfaces through further melting down, or the like; in which case the laser beam is essentially horizontally deflected, for example through the scanner, so that the beam falls at a right angle upon a vertically-extending component side-surface. Through up-and-down movement by means of the height adjustment of the workpiece carrier, the angle of incidence of the laser beam can be maintained and thus a flat retouching undertaken.

Claims 3-8 relate to arrangements of the laser and, in particular, features regarding the beam guidance. Since, except in the case of the application of a light-transmission element in claim 7, the laser beam must be deflected several times on or inside the cross-slide arrangement, and in a sintering construction space contamination can occur through the vaporization of sintering material particles, it is useful to design the beam guidance of the laser beam in the most concealed manner possible. This is especially true with respect to the mirror or prism-like deflection elements.

Both the motor drive elements and the scanner mirror can be separately controlled. In this way—as already mentioned above—it is possible, for example with the maintaining of a beam-incidence angle onto the layer or surface to be processed, either to work with the cross-slide drive or to leave the cross-slide alone and undertake a very quick surface scanning through movement of the scanner mirror. Obviously, the combination of both movements is possible, for example through moving the motor cross-slide drive slowly over a surface in order to scan the surface and stochastically scanning individual zones of the surface by means of the scanner-mirror deflection.

It is also possible to address higher-order coarse scan-points with the cross-slide arrangement, leave the scanner support above these coarse scan-points, and then scan subzones in the sense of a fine scanning.

With particular advantage, a distance sensor can be arranged on the scanner support or on the scanner, by means of which sensor a distance measurement can be carried out simultaneously during the processing of the component. Defects possibly arising can thus be eliminated immediately during the processing. The distance measurement can take place by means of visible light or in the infrared region.

Advantageously, the distance sensor can be displaceable in the z-axis. Since the distance sensor is arranged on the scanner support and thus on the cross-slide drive, the displaceability in the z-axis is easily accomplished. In this way, after the processing of the component a distance measurement can be carried out and the measurement distance to the component shortened by means of displacement in the z-axis, which yields precise measurement results. Obviously, the distance measurement can also take place after the processing of the component.

Details relating to advantageous operating methods result from claims 15-25, the crucial point of the method consisting in the fact that, in the acting upon the construction layer or the component surface to be retouched or engraved, the angle of incidence of the laser beam is arbitrarily selectable. During the construction process, the material layer can be worked with essentially vertical angles of incidence, while during the retouching process the angle of incidence of the laser beam can be kept constant or varied, in order to enable a surface processing, for example, in undercuts, recesses, and the like.

In an advantageous further development of the invention, it is possible to follow the contours of the construction layer, i.e. the outer edge, through movement of the drive elements of the cross-slide arrangement and, according to the speed of travel of the cross-slide arrangement, control the laser output and/or the energy density of the laser beam onto the contour. This means that during slow travel the laser output is reduced. When the cross-slide arrangement travels more quickly over the contour lines, the laser output and/or the energy density of the laser beam onto the contour line can be raised. The objective of this measure is the most constant possible impingement of the contour line with laser energy, independent of the speed of travel of the cross-slide arrangement.

In claim 27 is taught an especially advantageous measure relating to the irradiation of the edge regions of components, the basis of the thought being the fact that the cross-slide arrangement is encumbered with a relatively high mass. Now, should the corners of edge regions, in particular the corners of contours of a workpiece, be followed with the laser beam, this would mean that the cross-slide arrangement must be guided precisely into the corners and there, for example, be turned around at a right or acute angles, depending on the corner contour of the component. In this, high negative and positive accelerations occur when one wishes to perform the irradiation solely through the movement of the cross-slide arrangement.

The teaching of claim 27 is intended to ensure that the movement of the cross-slide arrangement inside the corners takes place in a rounded manner, i.e. the corner is shortened through a radius, so that the scanner head, which is fixedly attached to the cross-slide arrangement, can carry out a continuous, i.e. constant, curving motion. The focus of the laser beam is guided into the corner of the edge region through a separate, synchronized tracking of the scanner mirror. The scanner mirror has a far lower mass than the collective scanner head, which is why this can be carried out at high construction speed without causing mechanical stress.

Another approach results from claim 28. This claim teaches that the corners of edge regions be followed with reduced speed of the cross-slide arrangement and that a speed-dependent output or energy-density control of the laser onto the surface to be irradiated be undertaken. The goal of this measure is a constant energy entry into the contour lines of the component.

According to claim 30, several construction spaces are provided in a machine housing, in which the single scanner support, which moves in a motorized manner according to a cross-slide, is movable between the construction spaces, i.e. swings back and forth between the construction spaces. Not merely two construction spaces can be arranged side-by-side in one machine housing, but rather, for example in an arrangement approximating a square, four construction spaces that can be visited in any arbitrary sequence, in order to build up or otherwise process, as described in the preamble of claim 1, four components in an essentially simultaneous manner in one machine. For example, this can proceed as follows:

construction space 1: exposure

construction space 2: coating

construction space 3: cooling phase of a just-exposed layer

construction space 4: cooling phase of a just-ablated layer

Obviously, other manners of proceeding are possible, for example having exposure occur in two adjacent construction spaces and coating occur in two other construction spaces.

According to claim 34, multiple functions can be assigned to the scanner support, namely, the latter can be provided with a mechanical or electromechanical universal sensor, the sensor head of which is suitable for arranging components for laser ablation or for aligning prefabricated components in a construction space with such precision that a building up on existing surface can take place through a coating process.

The extraction by suction of metal vapors, smoke, and metal spray is, on the one hand, associated with an improvement of the construction structure, and on the other hand smoke in a construction chamber always leads to a reduction of the effective laser power onto the construction surface. If the smoke is targeted, i.e. extracted by suction at the point of origin, then, in addition to a structural improvement of the component, an increase of the construction speed can be achieved.

Claim 36 relates to a targeted blowing of inert gas onto the metal powder or the surface to be ablated, which gas can be removed by suction via the suction apparatus in the immediate vicinity of the laser focus.

Claim 37 relates to the arrangement on the scanner support or on the scanner of a distance sensor, by means of which a distance measurement can take place already during the processing of the component. Likewise, according to claim 38 it is possible to have the distance measurement take place only or additionally after the processing of the component.

The invention is explained in detail with the aid of the advantageous embodiment examples illustrated in the drawings. These show:

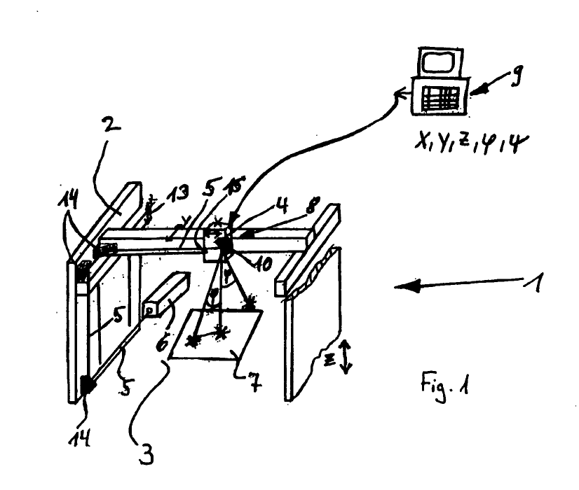

FIG. 1: a first embodiment form of the beam guidance of the device

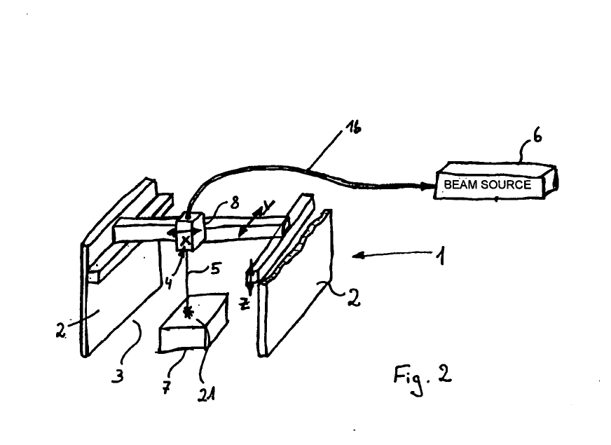

FIG. 2: a modified embodiment form of the beam guidance having a flexible light-conduction element

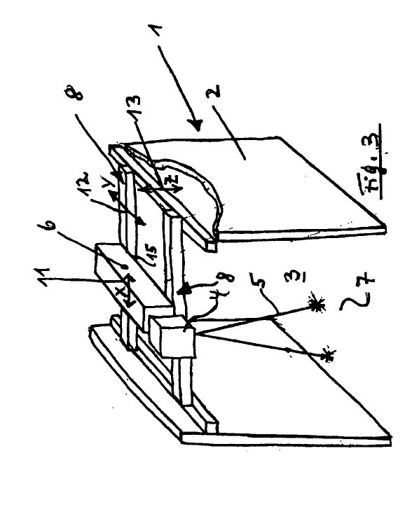

FIG. 3: a further embodiment form of the device having a movable laser-light source

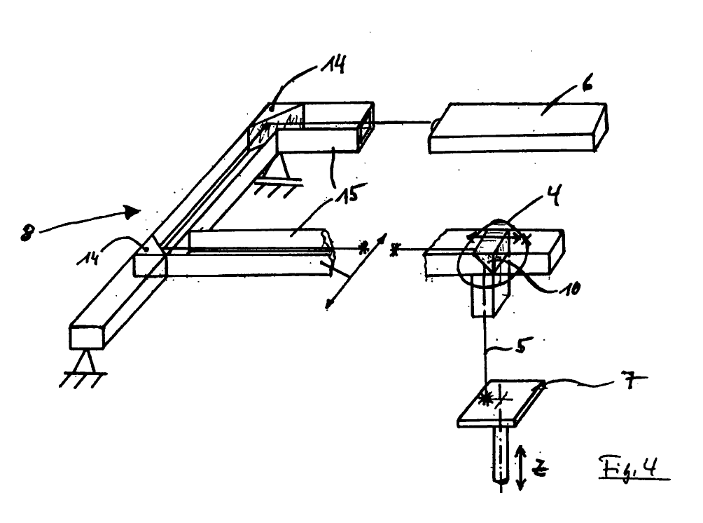

FIG. 4: an embodiment with concealed beam guidance

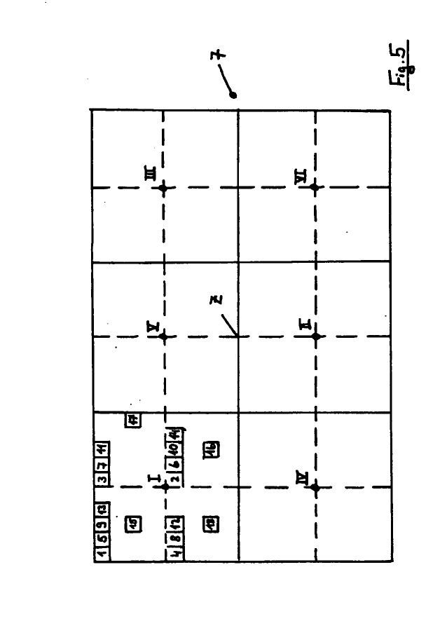

FIG. 5: a schematic representation of a scanning process of a construction layer using both the cross-slide drive and the scanner

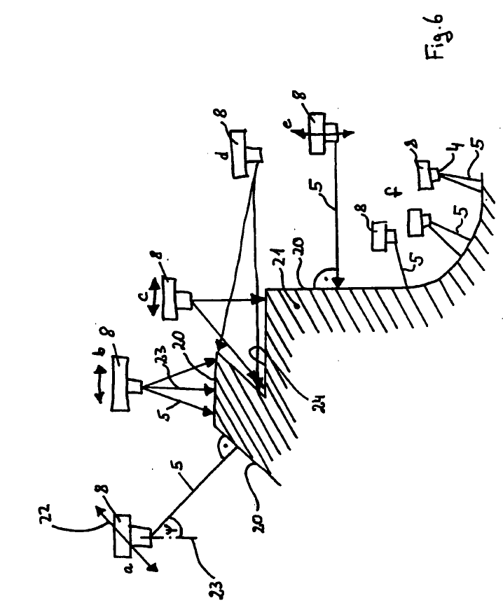

FIG. 6: a schematic representation of the beam guidance and movement of the components of the apparatus during a surface processing

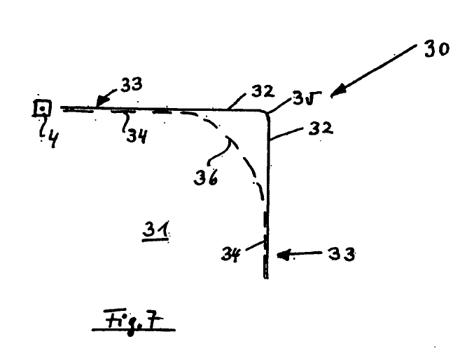

FIG. 7: a schematic representation of the guidance of the scanner and of the laser focus during the contour irradiation of the corner regions of a component

Referring first to FIG. 1, the device 1 according to the invention illustrated there displays a machine housing 2 indicated by walls, in which housing is accommodated a construction space 3. In the upper region of the construction space 3 is arranged a scanner 4, into which is transmitted the beam 5 of a sintering laser 6. Provided in the lower region of the construction space 3 are a vertically-displaceable workpiece platform 7 as well as a material supply device (not shown), by means of which the sintering material in powder, paste, or liquid form can be transported from a supply container (not shown) into the processing area over the workpiece platform (7).

The scanner 4 is movably arranged in the upper region of the construction space 3 on a scanner support 8 that is movable over the workpiece platform 7 in a motorized manner, the scanner support 8 being designed in the manner of a cross slide 15. Motor drive elements of the scanner support 8 are connected to a control computer 9, which is responsible for the entire course of the process. This control computer 9 controls, during the construction process, both the movement of the scanner 4 over the workpiece platform 7 and the movement of the scanner mirror 10 in the housing of the scanner 4. In addition to a possible displacement of the scanner 4 along the x-axis 11 and the y-axis 12, a displacement of the scanner 4 along the z-axis 13 is also possible, whereby the scanner 4 is vertically movable over the workpiece platform 7 or in the regions lying near the latter.

The radiation of the beam 5 of the sintering laser 6 into the region of the scanner support 8 takes place parallel to the axes 11, 12, and 13 of the suspension of the scanner support 8 and via 900 deflection mirrors, to the optical input of the scanner 4.

In the embodiment example represented in FIG. 1, the sintering laser 6 is attached to the machine frame, or to the machine housing 2. However, alternative sintering-laser arrangements are possible; for example, according to FIG. 3 the sintering laser 6 can be attached to a movable element of the cross-slide arrangement 15, namely to a transverse slide. Equally possible, according to FIG. 2 the output of the sintering laser 6 is connected to the scanner 4 via a flexible light-conducting element 16.

The cross-slide arrangement 15 of the scanner support 8 comprises pipe- or rod-like support element, and the laser beam 5 is at least partially guided inside these support elements. Likewise, diversion elements, as for example the 90° deflection mirrors 14, are located inside the support elements in the embodiment example represented in FIG. 4.

FIGS. 5 and 6 serve to illustrate an exemplary method of operation of the device 1.

Represented in FIG. 5 in plan view onto the workpiece platform 7 is a sintering-material layer, which is applied from the supply container by means of the material supply device. In order to solidify this layer, electromagnetic radiation in the form of the laser beam is focused onto the layer, whereby the latter is partially or completely melted down. According to the method this takes place such that the construction layer is divided by the process computer into a number of sectors, in the embodiment example six sectors. First, the center I of the first sector is addressed and the scanner fixed over the center I of the first sector. Then the scanner mirror is steered such that, for example, in four subquadrants the construction zones 1, 2, 3, 4, 5, etc. are scanned in succession. In this way, thermal overloadings of the construction layer are avoided. Of course, it is also possible to address small surfaces 16, 17, and 18 arbitrarily in stochastic distribution. Equally so, before the completion of a first sector I another sector, for example sector II, is partially or completely addressed and melted down, if this appears to be advantageous based on the structure of the workpiece, thermal stresses, and like factors. In an advantageous manner, in each case large angular deviations of the laser beam from the vertical are avoided, which deviations would occur if an immovable scanner head were arranged, for example, over the center Z of the construction layer.

FIG. 6 shows in a graphic manner how the displaceability along axes of the scanner support 8 can be utilized in order to retouch the surfaces 20 of an already-finished workpiece 21.

In position a, the scanner support 8 can be guided, for example, on a movement track 22 that runs parallel to the surface 20 to be processed. The deflection angle ψ of the beam 5 of the laser from the vertical 23 can thus be held constant, so that the angle of incidence of the beam 5 of the laser onto the surface 20 is always 90°.

In position b of the scanner support 8 it is likewise possible to either move the scanner support parallel to the surface to be processed 20 or to retouch the surface 20 through movements of the scanner mirror 10 with relatively small-angle deviations of the beam 5 from the vertical 23.

In position c, the scanner support 8 is brought into a lowered position, thus opening up the possibility of also illuminating undercuts 24, which otherwise would be perhaps inaccessible.

The same holds true for position d. In position e, the beam 5 of the laser can, for example, remain horizontally positioned, the scanner mirror 10 not being moved, and through movement of the scanner support 8 parallel to the surface 20, which faces position e, the surface can be processed; here, defined energy-density ratios are likewise prevalent, since the beam 5 of the laser always meets the surface 20 in a perpendicular manner.

In positions f, which are represented in the lower region of FIG. 6, it is even possible to allow the scanner support 8 to follow a curved path of movement, with the path arranged substantially parallel to a curved workpiece surface 20 to be processed. The scanner 4 is then able to project the laser beam 5 onto the surface always in a perpendicular manner, through successive adjustments of the scanner mirror 10, in order to ensure the intended retouching precision.

Seen in FIG. 7 is the corner region 30 of a workpiece with a workpiece surface 31. The contour line 32 of the corner region 30 should be traveled over once again by a laser beam in order to increase the precision of the component. In the straight region 33 of the contour line, the scanner 4 follows the contour line in a parallel manner along the dashed line 34; before the scanner reaches the corner 35 of the component surface 31, it turns off onto a shortened, curved line 36, so that the scanner 4, together with the elements of the cross-slide arrangement, can carry out a constant motion. The radius of the curved line 36 can be selected and optimized in consideration of the structural realities of the elements of the cross-slide arrangement.

A distance sensor 37 is arranged on the scanner support 8 (see FIG. 1), by means of which a distance measurement can be taken both during the processing of the workpiece and after the processing of the workpiece. Since the distance measuring device 37 is arranged on the scanner support 8, this device is likewise movable along its z-axis by the cross-slide drive. It is thus possible to carry out the distance measurement after the processing of the component with a shorter measurement distance, which can lead to more precise measurement results.

1. Device for sintering, removing material and/or labeling by means of electromagnetically bundled radiation, especially a laser sintering machine and/or a laser surface-processing machine, especially for carrying out stereolithographic methods, comprising a construction space (3) accommodated in a machine housing (2), in which construction space are provided a scanner (4), into which the beam (5) of a sintering laser (6) is transmitted, a vertically-displaceable workpiece platform (7), as well as a material supply device comprising a coater for supplying sintering material in powder, paste, or liquid form from a supply container into the process area above the workpiece platform, characterized in that the scanner (4) is arranged on a scanner support (8) that, by means of a motor, is movable above the workpiece platform (7) in the manner of a cross-slide, motor drive elements of the scanner support (8) being connected to a control computer (9) of the device (1) and being controlled by this computer during the construction process for the movement of the scanner (4) above the workpiece platform (7).

2. Device according to claim 1, characterized in that the scanner support (8) is arranged above the workpiece platform (7) in a vertically-displaceable manner.

3. Device according to claims 1 or 2, characterized in that the irradiation of the beam (5) of the sintering laser (6) into the region of the scanner support (8) takes place parallel to the axes (11-13) of the suspension of the scanner support (8) and is guided to the optical input of the scanner (4) via 90°-deflection mirrors (14).

4. Device according to one of the previous claims, characterized in that the sintering laser (6) is attached in a locationally-fixed manner to a machine frame connected to a cross-slide arrangement (15) of the suspension.

5. Device according to one of the previous claims, characterized in that the sintering laser (6) is movable parallel to an axis (12) of the cross-slide arrangement (15).

6. Device according to claim 5, characterized in that the sintering laser (6) is attached to a movable element of the cross-slide arrangement (15).

7. Device according to one of the previous claims, characterized in that the sintering laser (6) is connected to the scanner (4) via a flexible light-conducting element (16).

8. Device according to one of the previous claims, characterized in that the cross-slide arrangement (15) of the scanner support (8) comprises pipe- or rod-like support elements and that the laser beam (5) is guided and/or deflected at least partially inside the support elements.

9. Device according to one of the previous claims, characterized in that the control computer (9) of the device (1) is designed for separate control of the motor drive elements of the cross-slide arrangement (15) and of the scanner mirror (10).

10. Device according to one of the previous claims, characterized in that at least two laser-light sources of different energy are arranged such that their beams (5) are guided through the at least one scanner (4) onto the workpiece surface or the material layer to be sintered.

11. Device according to one of the previous claims, characterized in that two scanners (4, 4′) are arranged on the scanner support (8), a laser-light source being assigned to each scanner (4, 4′).

12. Device according to one of the previous claims, characterized in that the additional laser-light source present in addition to the sintering laser (6) works in conjunction with an essentially fixed optical deflection device that is attached to the scanner support (8) and deflects perpendicularly and downwardly the beam (5) entering said deflection device.

13. Device according to one of the previous claims, characterized in that a distance sensor (37) is arranged on the scanner support (8) or on the scanner (4).

14. Device according to claim 13, characterized in that the distance sensor (37) is movable in the z-axis.

15. Method for operating a device having the features of claim 1, characterized in that construction zones lying in the edge region of large-volume workpieces are addressed during the construction process such that during the construction process the scanner deflects the laser beam with only relatively small angles relative to the vertical axis.

16. Method according to claim 15, characterized in that each workpiece layer to be sintered is divided by the control computer into construction zones, that during the illumination process the scanner is moved above the respective construction zone by the cross-slide arrangement, and that the beam deflection required inside the construction zone takes place through movement of the scanner mirror.

17. Method according to one of the claims 15 and 16, characterized in that the sequential irradiation of the construction zones with electromagnetic radiation (laser light) takes place such that the multiplicity of construction zones is addressed one after another in a stochastic sequence.

18. Method according to one of the claims 15-17, characterized in that the edge regions of the individual construction zones overlap.

19. Method according to one of the claims 15-17, characterized in that the edge regions of the individual construction zones are acted upon separately with laser light.

20. Method according to claim 19, characterized in that the separate acting upon the edge regions with laser light takes place through movement of the cross-slide arrangement while the scanner mirror motionless, especially with laser light falling perpendicularly onto the material layer to be sintered.

21. Method according to one of the previous claims 15-20, characterized in that workpiece surfaces or channel or interior surfaces running inside the workpiece are post-irradiated with laser light that strikes the construction layer or surface in a substantially perpendicular manner.

22. Method according to claim 21, characterized in that during the post-irradiation a densification or smoothing of the surfaces takes place.

23. Method according to one of the previous claims 15-22, characterized in that a fine processing of the surfaces of the workpiece takes place through the perpendicular-striking and thus precisely-defined focussing of the laser beam.

24. Method according to claim 23, characterized in that during the fine processing only the drive elements of the cross-slide arrangement are driven and the incident angle of the laser beam onto the construction surface is kept unchanged.

25. Method according to one of the previous claims 15-24, characterized in that the focus of the laser beam emerging from the at least one scanner and/or from the optical deflection device is adjusted during the construction or processing procedure for selective changing of the energy density that strikes the construction layer and/or surface, provided for which purpose are mororized focusing elements that are adjustable via the process computer.

26. Method according to one of the previous claims 15-25, characterized in that the contours of the construction layer are followed through movement of the drive elements of the cross-slide arrangement, the laser output and/or the energy density of the laser beam onto the contour being controlled dependent on the speed of travel.

27. Method according to one of the previous claims 19 or 20, characterized in that during the irradiation of corners of the edge regions the movement of the cross-slide arrangement occurs in a rounded manner inside the corners, so that the scanner can carry out a continuous curve-movement and the focus of the laser beam is guided through separate, synchronized tracking of the scanner mirror into the corners of the edge regions.

28. Method according to claim 20, characterized in that corners of edge regions are followed with reduced speed of the cross-slide arrangement and a speed-dependent output control and/or energy-density control of the laser onto the surface to be irradiated takes place.

29. Method for operating a device having the features of claim 1, characterized through synchronously controlled movement of the cross-slide arrangement and of the scanner mirror during the illumination of component contours and component surfaces.

30. Method for operating a device having the features of claim 1, characterized through provision of several construction spaces in one machine housing, the scanner support being movable between the construction spaces by motor in the manner of a cross slide.

31. Method according to claim 30, characterized in that the material supply device is likewise movable by motor among the several construction spaces.

32. Method according to one of the previous claims 30 or 31, characterized in that several material supply devices are provided, in each case one material supply device being assigned to one construction space.

33. Method according to one of the previous claims 30-32, characterized in that the coating of a construction surface in construction space takes place simultaneously with the illumination by the laser in another construction space.

34. Method for operating a device having the features of claim 1, characterized in that the scanner support carries a mechanical or electromechanical universal sensor, the sensor head of which serves for the high-precision arrangement of components during laser ablation and/or for the arrangement of prefabricated components in a construction space.

35. Method for operating a device having the features of claim 1, characterized through removal by suction of metal vapors, smoke, and metal spray during the laser operation through a suction element, especially ring-like, on the scanner carrier, the suction region tracking the immediate vicinity of the laser focus on the component surface.

36. Method for operating a device having the features of claim 1, characterized through blowing inert gas onto the metal powder to be melted down, which gas is supplied via a blower apparatus on the scanner carrier in the immediate vicinity of the laser focus and which is removed by suction via the suction device in the immediate area of the laser focus.

37. Method for operating a device having the features of claim 1, characterized in that arranged on the scanner support (8) or on the scanner (4) is a distance sensor (37), by means of which a distance measurement is made during the processing of the component.

38. Method for operating a device having the features of claim 1, characterized in that arranged on the scanner support (8) or on the scanner (4) is a distance sensor (37), by means of which a distance measurement is made after the processing of the component.
